(19) United States
(12) Patent Application Publication
(10) Pub. No.: US 2023/0211509 A1
(43) Pub. Date: Jul. 6, 2023

(54) GRIPPING DEVICES, SYSTEMS, AND METHODS

(71) Applicant: University of Washington, Seattle, WA (US)

(72) Inventor: Jeffrey Lipton, Seattle, WA (US)

(21) Appl. No.: 18/149,563

(22) Filed: Jan. 3, 2023

Related U.S. Application Data
(60) Provisional application No. 63/296,442, filed on Jan. 4, 2022.

(51) Int. Cl. B25J 15/00; B25J 17/02

(52) U.S. Cl. CPC B25J 15/0033; B25J 17/0208; B25J 15/008; B25J 15/06

(57) ABSTRACT

Gripper structures can be used to conform to and support complex surfaces. For example, a system described herein can include a gripper structure. The gripper structure can include a plurality of iterations in a series of layers. The series of layers can be arranged in a progression in which each successive layer is adjacent to a preceding layer. The series of layers can include an anchor layer including a single shape of the pattern. The series of layers can include intermediate layers including a plurality of shapes that are copies of the single shape and are more numerous and smaller than shapes in its preceding layer. The series of layers can include a base layer including the most and smallest shapes in the series of layers. The series of layers can also include a plurality of joints. Each shape on the base layer can include an adhesion promoting mechanism.

### CROSS-REFERENCES TO RELATED APPLICATIONS

This application claims the benefit of U.S. Provisional Application No. 63/296,442 filed Jan. 4, 2022, the entire contents of which are hereby incorporated for all purposes in their entirety.

### BACKGROUND OF THE INVENTION

Adhesion can be generated in grippers in a variety of ways. Wet adhesion can involve placing small amounts of liquid between two objects and using surface tension of a material to generate an adhesive force. Wet adhesion can require shapes to be physically close. Vacuum adhesion can involve a negative pressure area placed on a target surface so that external air pressure can generate a pressure differential and force a part of the target surface onto a suction device. Often, suction cups can be used to generate a low-pressure environment to promote the vacuum adhesion. The suction cups can conform to the target surface to ensure a near airtight seal to minimize pressure loss. Variations in surface curvature of the target surface can complicate use of the suction cups. The suction cups may need to deform and seal around the variations in surface curvature. Ideally, the suction cups can be normal to the target surface.

Mechanical adhesive grippers can rely on complex microstructures to generate friction. For instance, Gecko inspired grippers can generate a maximum amount of friction when sheared but can easily separate when not sheared. Spin microgrippers can rely on small networks of angled spines which can have strong adhesion when pressed against a grain of micro-spines but can have weak adhesion when pressed along the grain.

Electrostatic adhesion can include a capacitive device placed near an object. When the capacitive device is charged, either a charge distribution or a local dipole moment can form in the object. An attractive force can form between the charged capacitive device and the charge distribution or the local dipole moment. A gripper based on electrostatic adhesion may need to be close to a target object to be effective. Many capacitive devices used for electrostatic adhesion can be flat since these capacitive devices can be made via standard printed circuit board (PCB) methods. A surface of the target object may also need to be flat to minimize a separation distance between the gripper and the target object.

Fractal vices were invented in the 1920s. Fractal vices can be composed of self-similar rotating semicircles attached to other semicircles. When an irregular shape is placed in a fractal vice, the fractal vice can self-balance to locate points of contact around a surface of the irregular shape and conform to the surface. Compliant mechanism versions of fractal vices can be 3D printed. A semicircle of the compliant mechanism version can be attached with a compliant planar hinge. Semicircles can then be nested inside of each other to produce a self-balancing compliant vice. Both types of vices can act as pairs of self-balancing pivoting contacts in a plane to generate antipodal pressure on an object. Linear sets of balancing 1D structures with standard friction on device surfaces can be used in pairs to act as a vice or grip.

A windshield wiper can form an example of a self-balancing one-dimensional (1D) mechanism that is meant to be used on one side of an object. The windshield wiper can be used to conform to a single line on a surface of varying curvature with no adhesion to the surface. Instead, the windshield wiper can make a watertight seal to the surface and then move liquid along the windshield wiper as the windshield wiper slides across the surface.

Self-similar structures can be referred to as fractal structures. Fractal structures can be composed of a pattern that is repeated across several size scales. For instance, in 1D, a generalized cantor set can be made by removing a middle section of a line segment at each iteration of the repeated pattern. Remaining line segments can be shorter than an original line segment with a space between the remaining line segments. A resulting structure can have a fractal dimension of

$$- \frac{log ( 2 )}{log ( \frac{1 - γ}{2} )}$$

where γ is a percentage of total length removed in each iteration. In 2D, a fractal structure can include a quadratic cross with a fractal dimension of

$${log}_{\sqrt{5}} ( \frac{10}{3} )$$

where each segment can be replaced with a cross scaled by a factor of

$${5}^{\frac{1}{2}}$$

Another example can include a Sierpinski tetrahedron where each tetrahedron can be replaced by 4 tetrahedra to generate space in a structure.

### BRIEF SUMMARY OF THE INVENTION

A gripper structure can have adhesion to objects with complex structures. For example, a system described herein can include the gripper structure. The gripper structure can include a plurality of iterations of a pattern arranged in a series of layers. The series of layers can be arranged in a progression in which each successive layer can be adjacent to a respective preceding layer. The series of layers can include an anchor layer. The anchor layer can include a single shape of the pattern. The series of layers can also include at least one intermediate layer. The at least one intermediate layer can include a plurality of shapes that are at least partial copies of the single shape. The plurality of shapes can be more numerous and smaller in at least one dimension than shapes in the respective preceding layer. Additionally, the series of layers can include a base layer. The base layer can include at least partial copies of the single shape. The base layer can include the most shapes and the smallest shapes in at least one dimension of shapes in the series of layers. The series of layers can also include a plurality of joints distributed among the series of layers to connect each layer to the respective preceding layer. Additionally, the series of layers can include an adhesion promoting mechanism on each shape of the base layer. The gripper structure can conform to a surface of an object to enhance contact area between the object and each adhesion promoting mechanism.

In another example, a system described herein can include a sub-assembly for a gripper structure. The sub-assembly can include a plurality of iterations of a pattern arranged in a series of layers. The series of layers can be arranged in a progression in which each successive layer can be adjacent to a respective preceding layer. The series of layers can include an anchor layer. The anchor layer can include a single shape of the pattern. The series of layers can also include at least one intermediate layer. The at least one intermediate layer can include a plurality of shapes that are at least partial copies of the single shape. The plurality of shapes can be more numerous and smaller in at least one dimension than shapes in the respective preceding layer. Additionally, the series of layers can include a base layer. The base layer can include at least partial copies of the single shape. The base layer can include the most shapes and the smallest shapes in at least one dimension of shapes in the series of layers. Each shape of the base layer can be configured to receive an adhesion promotion mechanism. The gripper structure can be configured to conform to a surface of an object to enhance contact area between the object and each adhesion promoting mechanism. The series of layers can also include a plurality of joints distributed among the series of layers to connect each layer in a series of layers to its preceding layer.

In another example, a method described herein can include attaching a gripper structure to an object. The gripper structure can include a plurality of iterations of a pattern and a plurality of joints to connect each iteration to a previous iteration of the pattern. The method can also include conforming the gripper structure to a shape of the object to enhance contact area between the object and each adhesion promoting mechanism of a base layer of the plurality of iterations. Additionally, the method can include locking each joint of the plurality of joints in place, The method can also include lifting the object.

### BRIEF DESCRIPTION OF THE DRAWINGS

FIG. 1 is a schematic of a 2D self-balancing, self-similar gripper with three layers according to one example of the present disclosure.

FIG. 2 is a schematic of a self-balancing, self-similar gripper with an H-fractal pattern according to one example of the present disclosure.

FIG. 3 is a schematic of a linear version of a gripper based on a generalized cantor set according to one example of the present disclosure.

FIG. 4 is a schematic of a linear version of a gripper having a combination of directional layers according to one example of the present disclosure.

FIG. 5 is a flowchart of a process for supporting a target object using a self-balancing, self-similar gripper system according to one example of the present disclosure.

### DETAILED DESCRIPTION OF THE INVENTION

Certain aspects and examples of the present disclosure relate to incorporating adhesion mechanisms on surfaces of a base layer of a self-balancing mechanism. The self-balancing mechanism can include combinations of 1D or 2D self-balancing and self-similar structures. In some examples, the self-balancing mechanism can include a fractal structure of balancing units. Fractal structures can include structures that are self-similar on all length scales. Self-similar structures can include a set of objects or layers wherein each layer is a copy of an adjacent layer on a different scale. Fractal structures can include a base structure or an anchor layer that can be repeatedly used at different length scales.

By placing the adhesion mechanisms on surfaces of the base layer of the fractal structure of balancing units, a gripper system can have high adhesion to objects with complex surfaces. Adhesion mechanisms can benefit from highly aligned contact areas with a target object. The adhesion mechanisms can include suction cups, gecko adhesion materials, or electrostatics, for example. A main element of the fractal structure can be a two dimensional (2D) initial surface capable of taking loadings from contact with the target object to change configuration and self-balance forces across one or more dimensions to maximize contact area normal to a surface of the target object. The fractal structure may not need to be perfectly fractal. The fractal structure can include parameters that vary across interactions of scale of the adhesion mechanism. The parameters can include orientation of a surface, aspect ratio, or scaled spacing between components.

Layers within the gripper system can be connected by a series of joints. Each joint in the system of joints can include a locking mechanism that can help lock the gripper system in place after the gripper system conforms to a shape of a target object. The joints can include spherical joints, compliant mechanism joints, or rotational joints. Compliant mechanism joints can flex and bend. Types of materials that can be suitable for use in the compliant mechanism joints include materials with high cycle life. Examples of flexible materials with high cycle life can include flexible polyurethane, Teflon, or polypropylene.

One or more sensors can be included in or with one or more of the joints to record data. The data can include an angle of deformation for each substructure within the layers as well as a strain on the gripper system. The recorded data can provide a discretized sampling of a shape of the gripper system when in contact with a target object, as well as force distribution data for the gripper. The force distribution data can provide an estimate of where the target object is grasped as well as a quality of the grasp. Changes in the angles of deformation over time can be used to estimate a slip of the target object in contact with the gripper system.

The self-similar systems can be used as pads for a robotic gripper. One or more independently moving, self-similar, self-balancing pads can be placed on a target object to generate a grasp. The self-similar, self-balancing pads can be used as finger pads for a friction-based gripper. The finger pads can conform to the target object and promote friction and generate friction cones for each grasp point.

The self-similar, self-balancing pads can be used in zero degree of freedom grippers (also known as passive grippers) to automatically conform to a shape of a target object. The passive grippers can rely on contact points to generate friction cones that form a wrench closure of the target object. A key element to a failure for a passive gripper can be improper contact, so a self-similar, self-balancing system can generate more and better contact patches to improve grasping.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

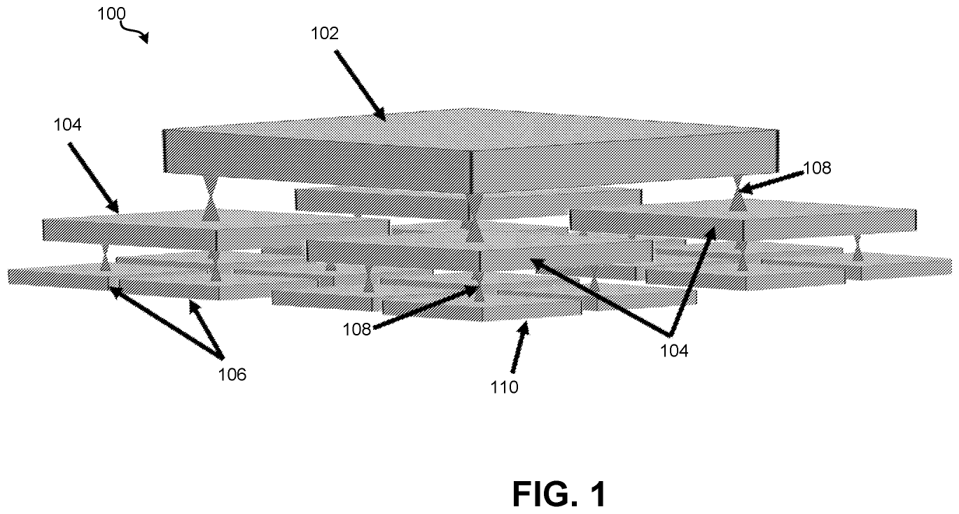

FIG. 1 is a schematic of a 2D self-balancing, self-similar gripper 100 with three layers according to one example of the present disclosure. Each of the three layers can include at least one rectangular plate. The rectangular plate can be a three-dimensional (3D) plate. While shapes of plates in FIG. 1 are shown to be rectangular, the shapes can include any regular polygon plate in addition to polygonal pyramids or truncated pyramids. A top layer or anchor layer can include an anchor plate 102, which may correspond to a single plate, such as a rectangular plate. Top ends of an upper level of spherical joints 108 can be attached at each corner of a bottom of the anchor plate 102. The spherical joints 108 can bend in two dimensions and resist tension and compression. Examples of spherical joints 108 can include ball and socket joints, universal joints, or joints with compliant mechanisms such as conical constrictions.

A second layer or intermediate layer of the self-similar gripper 100 can include a plurality of mid-level plates 104. The second layer can include more plates than the top layer. Four mid-level plates 104 are shown in FIG. 1. Any number of mid-level plates 104 can be included in the second layer according to various aspects of the present application. The mid-level plates 104 can be scaled-down versions of the anchor plate 102. Each mid-level plate 104 can have a same shape as the anchor plate 102 but a smaller surface area than a surface area of the anchor plate 102. Bottom ends of the upper level of spherical joints 108 can be attached to centers of top surfaces of the mid-level plates 104. Spaces between mid-level plates 104 can allow each of the mid-level plates 104 to pivot without interfering with any of the other mid-level plates 104. Top ends of a lower level of spherical joints 108 can be attached to each corner of a bottom of a mid-level plates 104.

A third layer or base layer of the self-similar gripper 100 can include a plurality of base plates 106. The base layer can include more plates than the second layer and the top layer. Sixteen base plates 106 (a few of the base plates 106 are hidden behind mid-level plates 104) are included in the base layer shown in FIG. 1. Any number of base plates 106 can be included in the base layer according to various aspects of the present application.

Bottom ends of the lower level of spherical joints 108 can be attached to centers of top surfaces of the base plates 106. The base plates 106 can be scaled-down versions of the mid-level plates 104. Each base plate 106 can have a same shape as each mid-level plate 104 but a smaller surface area than a surface area of each mid-level plate 104. Each base plate 106 can include an adhesion surface 110. The adhesion surface 110 can be a bottom surface of each base plate 106. In some examples, the adhesion surface 110 is a shear-based adhesion surface. In the examples that include shear-based adhesion surfaces, pairs of base plates 106 can be attached with tensioning elements to generate a pulling force between the pairs to generate shear. Alternatively, each base plate 106 can be configured to split in two via an internal mechanism to generate shear forces. In some examples, the adhesion surface 110 can correspond to a mounting interface for adhesion mechanisms such as suction cups, gecko adhesion materials, or electrostatics, for example.

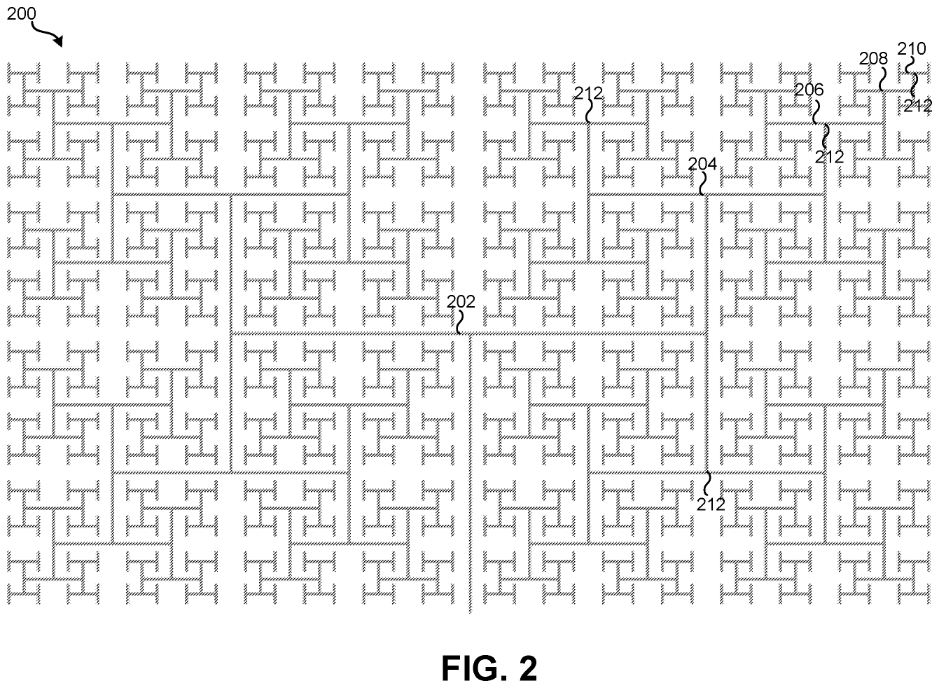

FIG. 2 is a schematic of a self-balancing, self-similar gripper 200 with an H-fractal pattern according to one example of the present disclosure. The H-fractal pattern can be arranged in a series of layers. Shapes in each layer can include two or more line segments and each line segment in a successive iteration can be less than half of a length of each line segment in an iteration of a preceding layer. The self-similar gripper can have a top layer or an anchor layer that includes a single H-fractal 202. The anchor layer can precede an initial intermediate layer. The initial intermediate layer can include four H-fractals 204. For simplicity, only one of the four H-fractals 204 includes a label in FIG. 2. Each of the four H-fractals 204 can be a scaled down version or copy of the single H-fractal 202 of the anchor layer. Each of the four H-fractals 204 can be attached to corners of the single H-fractal 202 at a point of contact 212 at a midpoint of each of the four H-fractals 204. For simplicity, only a few points of contact 212 out of many points of contact 212 among the various layers are labeled in FIG. 2. A hinge or joint can be included at each of the points of contact 212. The hinge can be rotational or spherical. In some examples, the hinge or joint can be a discrete rotational joint. In some examples, the hinge or joint can be provided by an orthogonal line segment. Additionally, the hinge can be composed of discrete components or a compliant joint.

The initial intermediate layer can precede a secondary intermediate layer. The secondary intermediate layer can include sixteen H-fractals 206. For simplicity, only one of the sixteen H-fractals 206 includes a label in FIG. 2. Each of the sixteen H-fractals 206 can be a scaled down version or copy of any of the four H-fractals 204 of the initial intermediate layer. Each of the sixteen H-fractals 206 can be attached to corners of one of the four H-fractals 204 at the point of contact 212 at a midpoint of each of the sixteen H-fractals 206.

The secondary intermediate layer can precede a tertiary intermediate layer. The tertiary intermediate layer can include sixty-four H-fractals 208. For simplicity, only one of the sixty-four H-fractals 208 includes a label in FIG. 2. Each of the sixty-four H-fractals 208 can be a scaled down version or copy of any of the sixteen H-fractals 206 of the secondary intermediate layer. Each of the sixty-four H-fractals 208 can be attached to corners of one of the sixteen H-fractals 206 at the point of contact 212 at a midpoint of each of the sixty-four H-fractals 208.

The tertiary intermediate layer can precede a base layer. The base layer can include 256 H-fractals 210. For simplicity, only one of the 256 H-fractals 210 includes a label in FIG. 2. Each of the 256 H-fractals 210 can be a scaled down version or copy of any of the sixty-four H-fractals 208 of the tertiary intermediate layer. Each of the 256 H-fractals 210 can be attached to corners of one of the sixty-four H-fractals 208 at the point of contact 212 at a midpoint of each of the 256 H-fractals 210. Each of the 256 H-fractals 210 can include an adhesion surface. The self-similar gripper 200 can include a height offset between the series of layers. Alternatively, all of the layers can lie in a single plane with offsets for the adhesion surfaces.

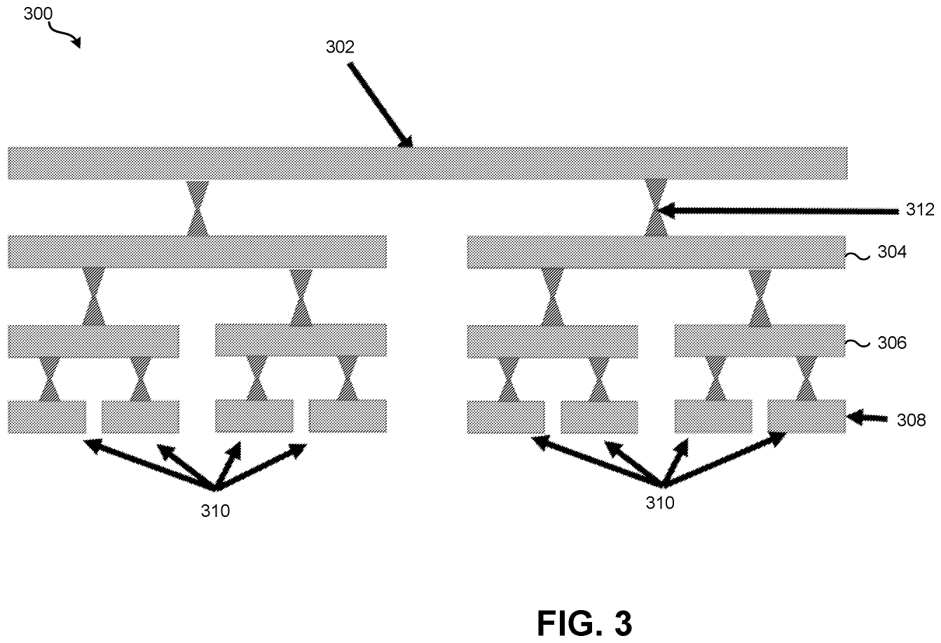

FIG. 3 is a schematic of a linear version of a gripper 300 based on a generalized cantor set according to one example of the present disclosure. To construct the generalized cantor set, a specified middle portion can be removed from each subinterval at every iteration stage of a repeated pattern. The gripper 300 can combine elements of similar fractal structures seen in some windshield wipers or a fractal vise with adhesion surfaces 310.

The gripper 300 can include four layers as depicted in FIG. 3. The layers can include a top layer or an anchor layer with a single line or single bar 302 with a rectangular cross-section as depicted in FIG. 3. Top ends of an upper level of joints 312 can be attached at locations along a bottom of the single bar 302. For simplicity only one of the joints 312 is labeled in FIG. 3.

A second layer or primary intermediate layer can include two bars 304. For simplicity, only one of the two bars 304 is labeled in FIG. 3. The two bars 304 can be scaled-down versions of the single bar 302 of the anchor layer. Each of the two bars 304 can have a same shape as but a smaller length than the single bar 302 of the anchor layer. Bottom ends of the upper level of joints 312 can be attached to centers of tops of the two bars 304. A space between the two bars 304 can allow each of the two bars 304 to pivot without interfering with another of the two bars 304. Top ends of an intermediate level of joints 312 can be attached at locations along bottoms of the two bars 304.

A third layer or secondary intermediate layer can include four bars 306. For simplicity, only one of the four bars 306 is labeled in FIG. 3. The four bars 306 can be scaled down versions of each of the two bars 304. Each of the four bars 306 can have a same shape as but a smaller length than each of the two bars 304. Bottom ends of the intermediate level of joints 312 can be attached to centers of the tops of the four bars 306. Spaces between the four bars 306 can allow each of the four bars 306 to pivot without interfering with any other bar of the four bars 306. Widths of the spaces between the four bars 306 can vary in size. Top ends of a bottom level of joints 312 can be attached at locations along bottoms of the four bars 306.

A fourth layer or base layer can include eight bars 308. For simplicity, only one of the eight bars 308 is labeled in FIG. 3. The eight bars 308 can be scaled down versions of the four bars 306. Each of the eight bars 308 can have a same shape as but smaller length than each of the four bars 306. Bottom ends of the bottom level of joints 312 can be attached to centers of the tops of the eight bars 308. Spaces between the eight bars 308 can allow each of the eight bars 308 to pivot without interfering with any other bar of the eight bars 308. Widths of the spaces between the eight bars 308 can vary in size. Bottoms of the eight bars 308 can include the adhesion surfaces 310. The adhesion surfaces 310 can include or be coupled with suction cups, gecko adhesion materials, electrostatics, or other adhesion mechanisms, for example.

To make a 2D adhesive section from the linear version of the gripper 300, such linear structures can be combined in multiple directions. The linear structures can be connected to each other using additional joints. To connect the linear structures, the additional joints can be aligned in an orthogonal direction to a direction of the joints 312 depicted in FIG. 3. For example, one end of each of the additional joints can be attached to one side of the single bar 302, the two bars 304, the four bars 306, or the eight bars 308. The other end of each of the additional joints can be attached to sides of bars included in another linear structure.

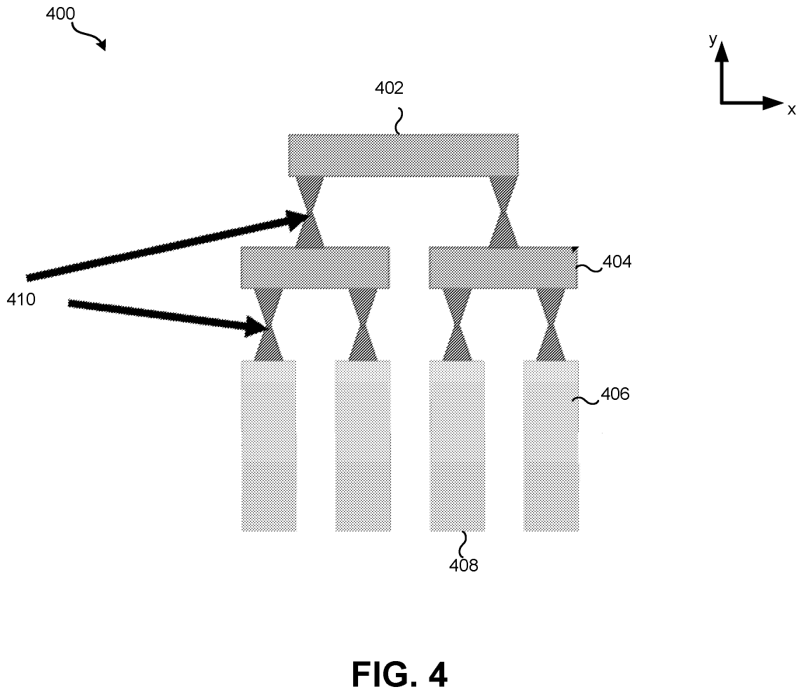

FIG. 4 is a schematic of a linear version of a gripper 400 having a combination of directional layers according to one example of the present disclosure. The gripper 400 can include three layers as depicted in FIG. 4. The layers can include a top layer or an anchor layer with a single line or single bar 402 with a rectangular cross-section as depicted in FIG. 4. The rectangular cross-section can lie in an x-y plane and include a x side and a y side. The x side can be referred to as a length of the rectangular cross-section and the y side can be referred to as the height. As depicted in FIG. 4, the length of the single bar 402 is longer than the height of the single bar 402. The single bar 402 can be referred to as an x-directional bar since the single bar 402 has a longer length than height. Top ends of an upper level of joints 410 can be attached at locations along a bottom of the single bar 402. For simplicity, only one of the joints 410 of the upper level of joints is labeled in FIG. 4.

A second layer or intermediate layer can include two bars 404. For simplicity only one of the two bars 404 is labeled in FIG. 4. The two bars 404 can be scaled-down versions of the single bar 402 of the anchor layer. Each of the two bars 404 can have a same cross-sectional shape as but a smaller length than the cross-section of the single bar 402. Cross-sections of the two bars 404 can have the same height as the cross section of the single bar 402. Bottom ends of the upper level of joints 410 can be attached to centers of tops of the two bars 404. A space between the two bars 404 can allow each of the two bars 404 to pivot without interfering with another of the two bars 404. Top ends of a bottom level of joints 410 can be attached along bottoms of the two bars 404. For simplicity, only one of the joints 410 of the bottom level of joints is labeled in FIG. 4.

A third layer or base layer can include four bars 406. For simplicity only one of the four bars 406 is labeled in FIG. 4. Each of the four bars 406 can have a similar cross-sectional shape as but a smaller length than the cross-sections of each of the two bars 404. The four bars 406 may be a continuation of a fractal pattern (e.g., based on having a smaller length than the two bars 402), notwithstanding that some aspects of the four bars 406 may differ with respect to other parameters and/or that the four bars 406 may be at least partial copies rather than scaled full copies of the two bars 404. For example, cross-sections of each of the four bars 406 can have a longer height than the cross-sections of each of the two bars 404. The four bars 406 can be referred to as y-directional bars since the four bars 406 have longer heights than lengths.

Bottom ends of the bottom level of joints 410 can be attached to centers of tops of the four bars 406. Spaces between each of the four bars 406 can allow each of the four bars 406 to pivot without interfering with another of the four bars 406. The spaces between each of the four bars 406 can vary in width. Bottoms of the four bars 406 can include adhesion surfaces 408. The adhesion surfaces 408 can include or be coupled with suction cups, gecko adhesion materials, electrostatics, or other adhesion mechanisms, for example.

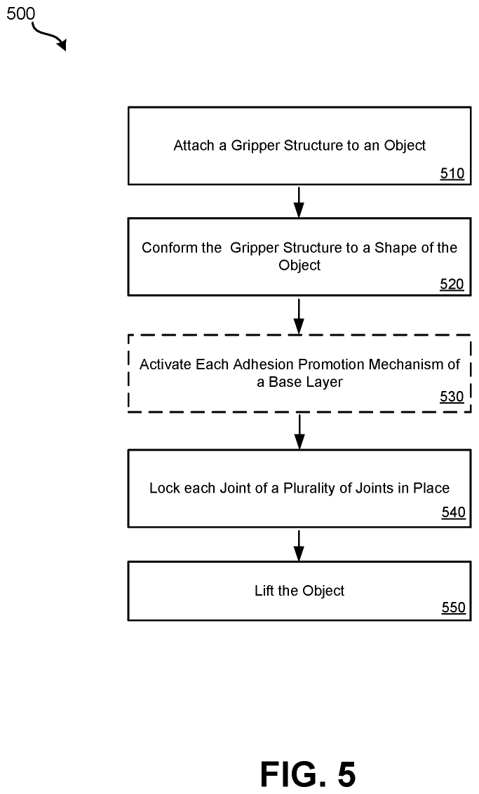

FIG. 5 is a flowchart of a process 500 for supporting a target object using a self-balancing, self-similar gripper system according to one example of the present disclosure. Operations of flowcharts may be performed by software, firmware, hardware, or a combination thereof. The operations of the flowchart start at block 510, and may be performed in the order indicated or in any other suitable order.

At block 510, the process 500 involves attaching a gripper structure to an object. The gripper structure can be a self-balancing, self-similar gripper structure. The gripper structure can include a plurality of iterations of a pattern arranged in a series of layers. The series of layers can be arranged in a progression in which each successive layer is adjacent to a respective preceding layer.

The series of layers can include an anchor layer including a single shape of the pattern. The series of layers can also include at least one intermediate layer that includes a plurality of shapes. The plurality of shapes in each intermediate layer can be at least partial copies of the single shape of the anchor layer. The plurality of shapes in each intermediate layer can be more numerous and smaller in at least one dimension than a number of shapes in each preceding layer. The series of layers can also include a base layer comprising a plurality of shapes that are copies of the single shape. The base layer can include the most shapes and smallest shapes in at least one dimension than other shapes in the series of layers. The series of layers can also include a plurality of joints to connect each layer in the series of layers to a preceding layer. Each shape in the base layer can include an adhesion promotion mechanism. In some examples, a sub-assembly for the gripper structure includes all aspects of the gripper structure except the base layer does not include adhesion promotion mechanisms. Each shape in the base layer of the sub-assembly may be configured to receive an adhesion promotion mechanism.

At block 520, the process 500 involves conforming the gripper structure to a shape of the object. The gripper structure can conform to the shape of the object in such a way that contact area is enhanced between the object and each adhesion promotion mechanism on each shape in the base layer. The shapes in the base layer can include pads. In some examples, conforming the gripper structure to the shape of the object can create moments that cause some of the pads in the base layer to bend.

At block 530, the process 500 involves activating each adhesion promotion mechanism of the base layer. Examples of activating adhesion promotion mechanisms can include activating vacuum, electrostatic, wetting, or shear-based adhesion promotion mechanisms. In some examples, the base layer can include a plurality of plates. The base layer can include a plurality of tensioning elements. Each tensioning element can generate a pulling force between a pair of plates in the base layer. The generated pulling forces can activate shear-based adhesion promotion mechanisms. In some examples, each plate in base layer can be split to generate shear forces. In some examples, activating each adhesion promotion mechanism at block 530 may be optional.

At block 540, the process 500 involves locking each joint of the plurality of joints in place. Locking each joint can promote good adhesion between the gripper structure and the object by removing the moments that cause some of the pads in the base layer to bend. Each joint can include a locking mechanism to allow each joint to lock in place. Examples of the locking mechanism can include an electrically activated brake, a vacuum actuated brake, a ratchet system, or a thermally activated brake. The locking mechanism can vary a stiffness of the gripper structure.

At block 550, the process 500 involves lifting the object. For example, the object may be lifted by the gripper structure engaged with the object in a state in which the gripper structure is conformed to the shape of the object and locked in that state of conformity by the joints being in a locked state.

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

It will be appreciated that, although specific embodiments of the disclosure have been described herein for purposes of illustration, various modifications may be made without deviating from the spirit and scope of the disclosure. Accordingly, the disclosure is not limited except as by the claims.

What is claimed is:

1. A system comprising:
a gripper structure comprising:
a plurality of iterations of a pattern arranged in a series of layers, the series of layers arranged in a progression in which each successive layer is adjacent a respective preceding layer, the series of layers comprising:
an anchor layer comprising a single shape of the pattern;
at least one intermediate layer comprising a plurality of shapes that are at least partial copies of the single shape and are more numerous and smaller in at least one dimension than shapes in its preceding layer;
a base layer comprising at least partial copies of the single shape and the most shapes and smallest shapes in at least one dimension of shapes in the series of layers;
a plurality of joints distributed among the series of layers to connect each layer in the series of layers to its preceding layer; and
an adhesion promoting mechanism on each shape of the base layer, wherein the gripper structure is configured to conform to a surface of an object to enhance contact area between the object and each adhesion promoting mechanism.

2. The system of claim 1, wherein the adhesion promoting mechanism is a vacuum, electrostatic, wetting, or shear-based adhesion promotion mechanism.

3. The system of claim 1, wherein the shapes are three-dimensional plates.

4. The system of claim 3, wherein the plurality of joints comprises a plurality of spherical joints, each spherical joint resistant to tension and compression and configured to bend in two dimensions.

5. The system of claim 4, wherein each spherical joint comprises a ball and socket joint, a universal joint, or a compliant mechanism.

6. The system of claim 3, wherein the adhesion promoting mechanism is a shear-based adhesion promotion mechanism.

7. The system of claim 6, wherein the base layer comprises a plurality of tensioning elements, each tensioning element configured to generate a pulling force between a pair of plates in the base layer.

8. The system of claim 6, wherein each plate in the base layer of the series of layers comprises an internal mechanism configured to split each plate to generate shear forces.

9. The system of claim 3, wherein the three-dimensional plates comprise polygon plates, polygonal pyramids, or truncated pyramids.

10. The system of claim 1, wherein the plurality of joints are configured to lock in place.

11. The system of claim 1, wherein the pattern is a fractal pattern.

12. The system of claim 11, wherein each shape comprises two or more line segments and wherein each line segment in a successive iteration is less than half of a length of each line segment in an iteration of the preceding layer.

13. The system of claim 11, wherein the fractal pattern is an H-fractal pattern.

14. The system of claim 13, wherein the plurality of joints comprises a plurality of discrete rotational joints.

15. The system of claim 1, wherein the plurality of joints comprises a plurality of sensorized joints, each sensorized joint of the plurality of sensorized joints configured to measure a change of an angle associated with each sensorized joint.

16. The system of claim 1, further comprising one or more strain sensors.

17. A system comprising:
a sub-assembly for a gripper structure, the subassembly comprising:
a plurality of iterations of a pattern arranged in a series of layers, the series of layers arranged in a progression in which each successive layer is adjacent a respective preceding layer, the series of layers comprising:
an anchor layer comprising a single shape of the pattern;
at least one intermediate layer comprising a plurality of shapes that are at least partial copies of the single shape and are more numerous and smaller in at least one dimension than shapes in its preceding layer;
a base layer comprising at least partial copies of the single shape and the most shapes and smallest shapes in at least one dimension of shapes in the series of layers, each shape of the base layer configured to receive an adhesion promotion mechanism; and
a plurality of joints distributed among the series of layers to connect each layer in the series of layers to its preceding layer.

18. A method comprising:
attaching a gripper structure to an object, the gripper structure comprising a plurality of iterations of a pattern and a plurality of joints to connect each iteration to a previous iteration of the pattern;
conforming the gripper structure to a shape of the object to enhance contact area between the object and each adhesion promoting mechanism of a base layer of the plurality of iterations;
locking each joint of the plurality of joints in place; and
lifting the object.

19. The method of claim 18, further comprising activating each adhesion promoting mechanism of the base layer.

20. The method of claim 18, wherein activating each adhesion promotion mechanism comprises applying shear forces to each adhesion promotion mechanism.
